(19) United States
(12) Patent Application Publication
(10) Pub. No.: US 2004/0028215 A1
(43) Pub. Date: Feb. 12, 2004

(54) Communication device employing a low impedance transformer

(75) Inventor: Jeong-Baek Lee, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD, Suwon-city (KR)

(21) Appl. No.: 10/464,641

(22) Filed: Jun. 19, 2003

(30) Foreign Application Priority Data
Aug. 6, 2002 (KR) 2002-46358

(51) Int. Cl. H04M 1/00; H04M 9/00

(52) U.S. Cl. 379/399.01; 379/402

(57) ABSTRACT

A communication interface circuit is connected to a tip terminal and a ring terminal establishing a call connection through a public switched telephone network to provide an interface between a modem and the public switched telephone network. The communication interface circuit includes a first capacitor, a transformer, and a first resistor. The first capacitor is serially connected to the tip terminal. The transformer has a primary coil connected to the first capacitor and a secondary coil connected to the modem. The transformer includes a low impedance to match an impedance between the modem and the public switched telephone network. The first resistor is serially connected to the primary coil of the transformer.

### CROSS-REFERENCE TO RELATED APPLICATIONS

This application claims the benefit of Korean Application No. 2002-46358, filed Aug. 6, 2002, in the Korean Intellectual Property Office, the disclosure of which is incorporated herein by reference.

### BACKGROUND OF THE INVENTION

1. Field of the Invention

The present invention relates to a communication interface circuit for establishing a call connection through a public switched telephone network and providing an interface between signals outputted from a modem and signals input from the public switched telephone network, and more particularly, to a communication interface circuit using a low impedance transformer.

2. Description of the Related Art

A telephone set or a facsimile, which is a terminal for data communication such as audio, document, and video data, is an office automation apparatus for transmitting or receiving data through a public switched telephone network. Recently, conventional office automation apparatuses such as the facsimile, a printer, a scanner and a copying machine, each configured as one single product, have been integrated into a multifunction apparatus, which is used as a multifunction terminal.

The telephone set, the facsimile and the multi-function terminals are referred to as communication terminals. The communication terminal includes a transformer to match an impedance with a system, wherein the transformer is coupled with a tip line and a ring line for data input and output.

Telecommunication standards require that an on-hook impedance should be over 10K at a frequency band (from about 4 KHz to about 20 KHz) beyond a voice band. The communication terminal uses the transformer with a high impedance (about 30 kΩ) to detect a caller ID and a remote reception in an on-hook mode (or idle mode). Accordingly, a conventional interface circuit uses the transformer having the high impedance to meet the on-hook impedance requirement and to detect signals in the idle mode, thereby causing a cost thereof to increase.

A transformer used by a communication interface circuit has higher impedance than the impedances of the transformer in the communication terminal, thus, causing a possibility of confusing one with the transformers and incompatibility.

### SUMMARY OF THE INVENTION

To solve the above-mentioned problems, according to an aspect of the present invention, there is provided a communication interface circuit employing a low impedance transformer, wherein the interface circuit is configurable with a low impedance in an on-hook state.

Additional aspects and advantages of the invention will be set forth in part in the description which follows and, in part, will be obvious from the description, or may be learned by practice of the invention.

According to an aspect of the present invention, there is provided a communication interface circuit connected to a tip terminal and a ring terminal of a telephone line to provide an interface between input and output signals from a public switched telephone network and a modem, the communication interface circuit including: a switch switching between an on-hook mode and an off-hook mode; a first capacitor serially connected to the tip terminal cutting off DC components of signals input from the public switched telephone network, upon switching to the on-hook mode to pass only AC components therethrough; a first resistor serially connected to the ring terminal in the on-hook mode; and a transformer having a primary coil connected between the first capacitor and the first resistor and a secondary coil connected to the modem to match an impedance between the modem and the public switched telephone network, wherein the first resistor is a resistor with a high impedance to make a combined impedance of the first resistor and the transformer high. Also, the transformer has a low impedance.

According to an aspect of the present invention, the communication interface circuit further includes a second capacitor connected in parallel to the secondary coil of the transformer; a pair of diodes connected between the secondary coil of the transformer and the second capacitor to protect the second capacitor against a voltage overload; and a second resistor connected in parallel to the second capacitor to compensate for the signals attenuated by the first resistor.

According to an aspect of the present invention, there is provided a communication interface circuit connected to a tip terminal and a ring terminal establishing a call connection through a public switched telephone network and providing an interface between a modem and the public switched telephone network, the communication interface circuit including: a first capacitor serially connected to the tip terminal; a transformer having a primary coil connected to the first capacitor and a secondary coil connected to the modem, the transformer having a low impedance to match an impedance between the modem and the public switched telephone network; and a first resistor serially connected to the primary coil of the transformer.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a block diagram illustrating a construction of a facsimile machine; and

FIG. 2 is a block diagram of a communication interface circuit, in accordance with an aspect of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

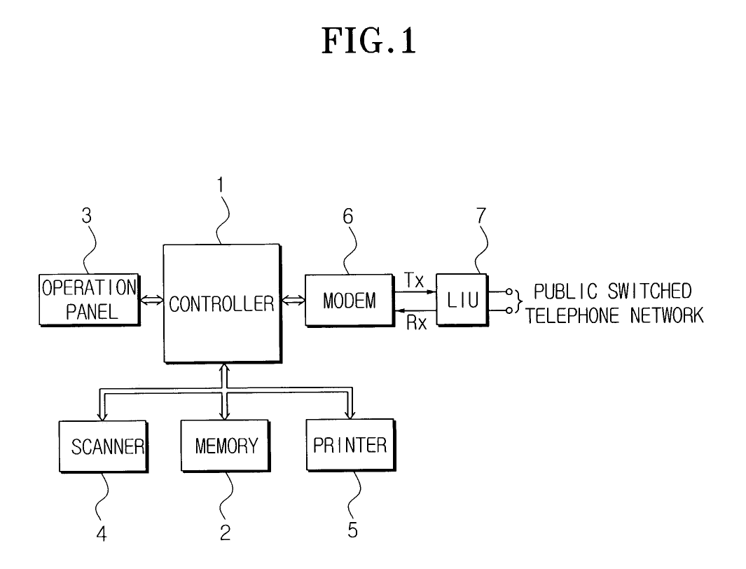

FIG. 1 is a block diagram illustrating a construction of a facsimile machine.

A controller 1 of the facsimile machine controls the facsimile machine overall in accordance with a predetermined program. A memory 2 includes a ROM (Read Only Memory) to store various kinds of control programs necessary to implement functions of the facsimile machine, and a RAM (Random Access Memory) to store various kinds of data, such as protocol data and character data generated in accordance with an execution of the control programs. The memory 2 accesses and stores the data under a control of the controller 1.

An operation panel 3 includes a plurality of keys to input key data and transmits the input key data to the controller 1 and a display window for display. A scanner 4 scans a manuscript and transmits the scanned manuscript to the controller 1. A printer 5 prints received facsimile data, a report of the facsimile machine, etc. on a recording paper for displaying.

A modem 6 modulates input data to output analog data under a control of the controller 1, and demodulates analog signals. An LIU (Line Interface Unit) 7 is operated under a control of the controller 1 to establish a call connection through a public switched telephone network to provide interfaces between signals output from the modem 6 and signals input from the public switched telephone network.

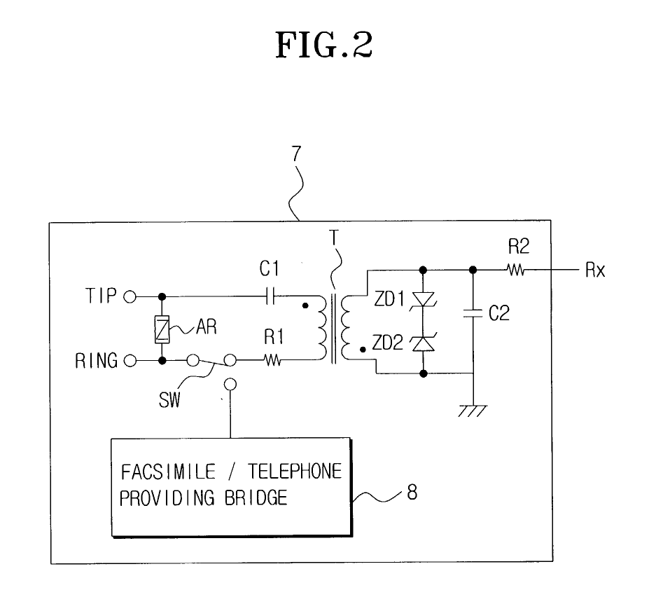

FIG. 2 is a block diagram of a communication interface circuit, in accordance with an aspect of the present invention.

As shown in FIG. 2, the communication interface circuit includes an arrest AR connected between a tip terminal TIP and a ring terminal RING, a first capacitor C1 serially connected to the tip terminal for DC coupling, a transformer T having a primary coil connected to the first capacitor C1 and a secondary coil connected to the modem 6, a first resistor R1 serially connected to the primary coil of the transformer T, and a switch SW for switching between an on-hook mode and an off-hook mode. The communication interface circuit further includes a second capacitor C2 connected in parallel to the secondary coil of the transformer T, a pair of zener diodes ZD1 and ZD2 connected between the secondary coil of the transformer T and the second capacitor C2, and a second resistor R2 connected in parallel to the second capacitor C2.

The arrest AR is a surge protection element in order to protect a communication terminal against over-voltage applied by thunderbolt, lightning, etc. The first capacitor C1 cuts off DC components from signals input through the public switched telephone network and passes only AC components therethrough.

The communication interface circuit uses the transformer T with a low impedance (about 600 Ω) and the first resistor R1 with an impedance from about 20 to about 30 kΩ so as to have a high impedance.

The second resistor R2 is a resistor of several kilo-ohms so as to compensate signals attenuated by the first resistor R1. The zener diodes ZD1 and ZD2 protect the second capacitor C2 against a high-voltage. The secondary coil of the transformer T may be selectively protected by the pair of zener diodes ZD1 and ZD2. The switch SW is connected to the ring terminal in the on-hook mode and to a facsimile/telephone providing a bridge 8 in the off-hook mode.

In the on-hook mode, the ring terminal RING and the first resistor R1 are serially connected with each other and the first resistor R1 has the high impedance, thereby causing a combined impedance of the first resistor R1 and the transformer T to be high. Accordingly, the standard requiring that the on-hook impedance is high can be met.

From signals input through the public switched telephone network, the DC components are cut off by the first capacitor C1 and only the AC components are passed therethrough. The AC components of the input signals are amplified by the transformer T to have the high voltage, allowing the LIU 7 to detect inward input AC signals input from an external source in the on-hook mode. Upon inputting AC signals to the modem 6, the modem 6 reads the input signals to display a caller ID or to perform auto-reception.

In accordance with an aspect of the present invention, a transformer having a low impedance is used to implement a high impedance characteristic, thereby meeting an on-hook impedance standard and further detecting inward input signals. Also, manufacturing costs can be reduced and parts can be shared, thereby preventing inoperability with the transformer.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A communication interface circuit connected to a tip terminal and a ring terminal of a telephone line to provide an interface between input and output signals from a public switched telephone network and a modem, the communication interface circuit comprising:
a switch switching between an on-hook mode and an off-hook mode;
a first capacitor serially connected to the tip terminal, cutting off DC components of signals input from the public switched telephone network, upon switching to the on-hook mode to pass only AC components therethrough;
a first resistor serially connected to the ring terminal in the on-hook mode; and
a transformer having a primary coil connected between the first capacitor and the first resistor and a secondary coil connected to the modem to match an impedance between the modem and the public switched telephone network,
wherein the first resistor is a resistor with a high impedance to make a combined impedance of the first resistor and the transformer high.

2. The communication interface circuit according to claim 1, wherein the transformer has a low impedance.

3. The communication interface circuit according to claim 1, further comprising:
a second capacitor connected in parallel to the secondary coil of the transformer;
a pair of diodes connected between the secondary coil of the transformer and the second capacitor to protect the second capacitor against a voltage overload; and
a second resistor connected in parallel to the second capacitor to compensate for the signals attenuated by the first resistor.

4. The communication interface circuit according to claim 1, wherein the tip terminal and the ring terminal are exchangeable.

5. A communication interface circuit connected to a tip terminal and a ring terminal establishing a call connection through a public switched telephone network and providing an interface between a modem and the public switched telephone network, the communication interface circuit comprising:
a first capacitor serially connected to the tip terminal;
a transformer having a primary coil connected to the first capacitor and a secondary coil connected to the modem, the transformer having a low impedance to match an impedance between the modem and the public switched telephone network; and
a first resistor serially connected to the primary coil of the transformer.

6. The communication interface circuit according to claim 5, wherein the impedance of the transformer is 600 Ω and an impedance of the first resistor is between 20 kΩ and 30 kΩ.

7. The communication interface circuit according to claim 5, further comprising:
an arrest connected between the tip terminal and the ring terminal; and
a switch switching between an on-hook mode and an off-hook mode.

8. The communication interface circuit according to claim 5, further comprising:
a second capacitor connected in parallel to the secondary coil of the transformer;
a pair of diodes connected between the secondary coil of the transformer and the second capacitor; and
a second resistor connected in parallel to the second capacitor.

9. The communication interface circuit according to claim 8, wherein the second resistor is a resistor of a high impedance to compensate signals attenuated by the first resistor.

10. The communication interface circuit according to claim 8, wherein the switch is connected to the ring terminal in the on-hook mode and to a facsimile/telephone providing a bridge in the off-hook mode.

11. The communication interface circuit according to claim 7, wherein in the on-hook mode, the ring terminal and the first resistor are serially connected with each other and the first resistor has a high impedance, causing a combined impedance of the first resistor and the transformer to be high.
